(19) United States
(12) Patent Application Publication
(10) Pub. No.: US 2004/0200131 A1
(43) Pub. Date: Oct. 14, 2004

(54) Method and apparatus for the control of vermin

(76) Inventors: John Stephen Middlebrook, Wellington, FL (US); Beverly Diane Middlebrook, Wellington, FL (US); Christopher Todd Middlebrook, Wellington, FL (US); David Austin Middlebrook, Wellington, FL (US); Heide Alexandra Middlebrook, Wellington, FL (US)

Correspondence Address: J. Rodman Steele, Jr., Akerman Senterfitt, P.O. Box 3188, West Palm Beach, FL, 33401, US

(21) Appl. No.: 10/387,795

(22) Filed: Mar. 13, 2003

(51) Int. Cl. A01M 1/00

(52) U.S. Cl. 43/124

(57) ABSTRACT

An apparatus for the delivery of toxicant to vermin includes an expandable conduit having an entry and exit for vermin, and which is expandable upon installation into an area determined to be suitable for vermin control. A toxicant is placeable in the expanded conduit such that vermin will contact the toxicant when passing through the conduit. In another apparatus, a toxicant is disposed within a conduit having an entry and exit for vermin. The toxicant is secured within the conduit to prevent spillage of the toxicant upon installation of the apparatus. The toxicant may be preloaded in a container. Methods for using the apparatuses are also described.

### 1. FIELD OF THE INVENTION

The present invention relates to a method and apparatus for the control of vermin, particularly rats, cockroaches and similar animals.

### 2. DISCUSSION OF THE PRIOR ART

Many forms of vermin control have been attempted. While many systems are successful for vermin such as termites, cockroaches, and rodents such as mice, it has proven to be extremely difficult to control rat populations. This difficulty is due to the fact that rats are social and intelligent animals, and can associate a trap or bait station with the death of a member of the group that has come into contact with a known method of extermination. The remaining members of the group then avoid the trap or bait station, preventing their capture.

Furthermore, as rats are nocturnal animals, it is sometimes difficult to determine the number of rats present in a particular area. As a result, if several rats are captured in a particular area, in may appear that the rat population in the area has been eliminated, when in fact the problem has not been resolved. When rats are subsequently noticed in the same area, it is often erroneously believed that a new rat population has moved into the area, whereas in reality the original population was never eliminated.

Rats and some other rodents do not like to cross open spaces, and are typically found in enclosed spaces such as in the voids between the walls of a building, or in attic spaces. Many known bait stations therefore employ housing or other confined spaces that a rodent is likely to be attracted into so that the rodent contacts poison, and then ingests it during grooming. Such known bait stations include those described in U.S. Pat. Nos. 4,349,981, 4,753,032, 4,835,902, 4,831,775 and 4,905,407 to Sherman, U.S. Pat. No. 4,908,976 to Dagenais, U.S. Pat. No. 4,825,581 to Dailey, U.S. Pat. No. 5,136,803 to Sykes et al., U.S. Pat. No. 4,132,026 to Dodds and U.S. Pat. No. 5,027,548 to Anderson, among others.

Such known bait stations can be complicated or difficult to install, particularly if a person has to carry the bait station to an attic or roof rafter, or place the bait station into a confined space. It is often difficult to load the poison into a bait station after it has been placed into a selected location, and if the poison is preloaded into the bait station, it can spill during placement. Even if the bait station can be placed without spillage of the poison, rodents can learn that it contains poison, and a colony can easily avoid the bait station after the death of one or two members of the colony.

### SUMMARY OF THE INVENTION

One embodiment of the invention relates to an apparatus for the delivery of toxicant to vermin. The apparatus includes an expandable conduit having an entry and exit for vermin. The conduit is expandable upon installation into an area determined to be suitable for vermin control. A toxicant is placeable in the expanded conduit such that vermin will contact the toxicant when passing through the conduit.

In one arrangement, toxicant is preloaded into the conduit when the conduit is in a collapsed configuration prior to expansion. The conduit may be reversibly expandable.

A container may be included for the storage of the toxicant. The container may be breachable to release the toxicant into the conduit. The toxicant may be released from the container upon expansion of the conduit. In one arrangement, a linking element may couple the container and a portion of the conduit, so that the linking element can cause breach of the container upon expansion of the conduit. The container may have perforations enabling breach of the container.

The container may be refillable, or replaceable. The container may be formed of any suitable material, including plastic material, and may be deformable. The container may be located substantially near a midpoint of the conduit.

In one arrangement, the conduit may have folds enabling expansion and contraction of the conduit. The folds may extend around a circumference of the conduit. The conduit may be formed of a deformable material that is sufficiently rigid so as to retain the shape of the conduit. The conduit may be formed of thin metal, for example, of aluminum.

In another arrangement, the conduit may have at least one rigid reinforcement member extending around a circumference of the conduit, and a deformable material. There may be a plurality of reinforcement members, with each reinforcement member substantially circular. The deformable material may extend between the plurality of reinforcement members to form an expandable and collapsible tube.

End sealing elements may be included. The end sealing elements may be end caps. An aperture may be included for replenishment of the toxicant. End grasping sections may be included to enable the end of the conduit to be grasped for expansion and contraction.

The toxicant may include an active ingredient which forms less than 2% of the toxicant. In one arrangement, the active ingredient is less than 0.2% of the toxicant. The active ingredient may be an anticoagulant. The active ingredient may be 2-Diphenylacetyl-1,3-indandione. The active ingredient may be any suitable poison, anti-coagulant or other rodenticide or insecticide. An attractant may be included.

The vermin to be controlled is preferably a rodent, for example, a rat. Alternatively, the vermin to be controlled may be an insect, such as a cockroach.

In one arrangement, at least two conduits are used, which are connectable together. The conduits may be connectable together by a connector. The connector may be a snap-fit on ends of the conduits. The connector may be any suitable shape, for example straight, right-angled, T-shaped, cross-shaped, and U-shaped.

Another embodiment of the invention relates to a method for the delivery of toxicant to vermin. The method includes providing an expandable conduit having an entry and exit for vermin. The conduit is expanded to provide a passageway for the vermin. The conduit is located in an area selected for vermin management, and the toxicant is disposed within the conduit.

The conduit may be reversibly expandable.

The toxicant may be preloaded into the conduit prior to location of the conduit in the selected area. In one arrangement, the conduit includes a container for the storage of the toxicant, the method including the step of filling the container with the toxicant prior to expansion of the conduit.

The container may be breachable, the method including breaching the container on placement of the conduit to thereby release the toxicant into the conduit. The toxicant may be released from the container upon expansion of the conduit. A linking element can couple the container and a portion of the conduit such that the linking element causes the breach of the container upon expansion of the conduit.

The method may include the step of placing a plurality of conduits into the selected area.

The method may also include the step of securing the conduit into a desired location within the selected area. The location for placement of the conduit may be selected based on behavioral patterns of the vermin. The locations can be, for example, voids between walls of a building, attics, roof spaces, basements, duct work, junctures of walls and floors, above suspended ceilings, beneath raised floors, and crawl spaces. Alternative locations may be external locations, such as in and around barns, silos and other storage facilities, alongside buildings, underneath buildings, along docks or in marinas, in subways or sewer systems, within fields of crops or pasture, in farming and recreational areas, around schools, factories, hospitals and places of work, yards and gardens of houses, and any other suitable location.

The conduit may include a fastener mechanism for maintenance of a collapsed configuration, the method including the step of unfastening the fastener to enable expansion of the conduit.

The conduit may include end sealing caps to enable transport of the conduit without spillage of the toxicant, and the method may include the step of removing the end caps on location of the conduit in the selected area.

The method may include selecting a toxicant having less than 2% of active ingredient. The active ingredient may be less than 0.2% of the toxicant. The active ingredient may be an anticoagulant. The active ingredient may be 2-Diphenylacetyl-1,3-indandione. The active ingredient may be any suitable poison, anti-coagulant or other rodenticide or insecticide. An attractant may be included.

The vermin to be controlled is preferably a rodent, for example, a rat. Alternatively, the vermin to be controlled may be an insect, such as a cockroach.

In one arrangement, at least two conduits are used, which-are connectable together. The conduits may be connectable together by a connector. The connector may be a snap-fit on ends of the conduits. The connector may be any suitable shape, for example straight, right-angled, T-shaped, cross-shaped, and U-shaped.

The conduit may include an aperture for replenishment of the toxicant, and the method may include the step of replenishing the toxicant after the toxicant has been delivered to the vermin. The replenishment of the toxicant may be refilling the toxicant in the conduit, or may be replacing the toxicant in the conduit.

Another embodiment of the invention relates to an apparatus for the delivery of toxicant to vermin which includes a conduit having an entry and exit for vermin and a toxicant disposed within the conduit between the entry and exit. The toxicant is secured within the conduit to prevent spillage of the toxicant upon installation of the apparatus.

A container may be included for the storage of the toxicant. The container may be located substantially near a midpoint of the conduit. The container may be refillable or replaceable.

The container may be breachable to release the toxicant into the conduit. In one arrangement, the container may have perforations enabling a breach of the container. The container may be formed of a deformable plastic material. The plastic material may be polyethylene.

In one arrangement, the conduit may have an aperture for replenishment of the toxicant. The aperture may include closure elements, which may be resealable.

The conduit may be expandable. A container for storage of the toxicant may be included, such that the toxicant is released from the container upon expansion of the conduit. A linking element may couple the container and a portion of the conduit, such that the linking element causes breach of the container upon expansion of the conduit.

The conduit may have folds enabling expansion and contraction of the conduit. The folds may extend around a circumference of the conduit. The conduit may be formed of a deformable material that is sufficiently rigid so as to retain the shape of the conduit. The conduit may be formed of thin metal, for example, of aluminum.

Alternatively, the conduit may include a least one rigid reinforcement member extending around a circumference of the conduit, and a deformable material. A plurality of reinforcement members may be provided. Each reinforcement member may be substantially circular. The deformable material may extend between the plurality of reinforcement members to form an expandable and collapsible tube.

End sealing elements may be included. The end sealing elements may be end caps. End grasping sections may be included to enable the end of the conduit to be grasped for expansion and contraction.

The toxicant may include an active ingredient which forms less than 2% of the toxicant. In one arrangement, the active ingredient may be less than 0.2% of the toxicant. The active ingredient may be an anticoagulant. The active ingredient may be 2-Diphenylacetyl-1,3-indandione. The active ingredient may be any suitable poison, anti-coagulant or other rodenticide or insecticide. An attractant may be included.

The vermin to be controlled is preferably a rodent, for example, a rat. Alternatively, the vermin to be controlled may be an insect, such as a cockroach.

In one arrangement, at least two conduits are used, which are connectable together. The conduits may be connectable together by a connector. The connector may be a snap-fit on ends of the conduits. The connector may be any suitable shape, for example straight, right-angled, T-shaped, cross-shaped, and U-shaped.

Yet another embodiment of the invention relates to a method for the delivery of toxicant to vermin, which involves the steps of providing a conduit having an entry and exit, providing a preloaded toxicant disposed within the conduit between the entry and exit, and locating the conduit in an area selected for vermin management.

The conduit may have a container for the storage of the toxicant, and the method may involve the step of filling the container with the toxicant prior to location of the conduit in the selected area. The container may be breachable and the method may include breaching the container on location of the conduit. The container may be refillable or replaceable.

In one arrangement, the conduit may be expandable, and the method may include releasing the toxicant from the container upon expansion of the conduit. The container may have perforations enabling a breach of the container. A linking element can couple the container and a portion of the conduit, so that the linking element causes the breach of the container upon expansion of the conduit.

The container may be located substantially near a midpoint of the conduit. The conduit is preferably sized to permit vermin to pass therein. In another arrangement, the conduit may have end sealing caps to enable transport of the conduit without spillage of the toxicant, the method including the step of removing the end caps on location of the conduit in the selected area.

The method may include selecting a toxicant having less than 2% of active ingredient. The active ingredient may comprise less than 0.2% of the toxicant. The active ingredient may be an anticoagulant. The active ingredient may be 2-Diphenylacetyl-1,3-indandione. The active ingredient may be any suitable poison, anti-coagulant or other rodenticide or insecticide. An attractant may be included.

The vermin to be managed is preferably a rodent, for example, a rat. Alternatively, the vermin to be controlled may be an insect, such as a cockroach.

In one arrangement, at least two conduits are used, which are connectable together. The conduits may be connectable together by a connector. The connector may be a snap-fit on ends of the conduits. The connector may be any suitable shape, for example straight, right-angled, T-shaped, cross-shaped, and U-shaped.

In one arrangement, the conduit may include an aperture for replenishment of the toxicant, and the method may include the step of replenishing the toxicant after the toxicant has been delivered to the vermin. The replenishment of the toxicant may be refilling or replacing the toxicant in the conduit.

The method can further include securing the conduit into a desired location.

The method may also include placing a plurality of conduits into the area. The location for placement of the conduit may be selected based on behavioral patterns of the vermin. The locations can be, for example, voids between walls of a building, attics, roof spaces, basements, duct work, junctures of walls and floors, above suspended ceilings, beneath raised floors, and crawl spaces. Alternative locations may be external locations, such as in and around barns, silos and other storage facilities, alongside buildings, underneath buildings, along docks or in marinas, in subway or sewer systems, within fields of crops or pasture, in farming and recreational areas, around schools, factories, hospitals and places of work, yards and gardens of houses, and any other suitable location.

A further embodiment of the invention relates to a method for the management of vermin from an area, which includes the steps of providing a toxicant having less than 2% active ingredient in a toxicant receptacle, locating a plurality of the toxicant receptacles in an area containing vermin, and managing the area by replenishment of the toxicant receptacles.

The active ingredient of the toxicant may form less than 0.2% of the toxicant. The active ingredient may be 2-Diphenylacetyl-1,3-indandione.

The method may also include removing toxicant receptacles from within the area, and locating a plurality of toxicant receptacles around the periphery of the area when the area is deemed vermin free.

A further step of the method may involve selecting a second area for vermin management adjoining the first area when the first area is deemed vermin free, repeating the method in the second area until the second area is deemed vermin free and providing a plurality of the toxicant receptacles around the periphery of the first and second adjoining areas, to expand the periphery of managed area.

### BRIEF DESCRIPTION OF THE DRAWINGS

There are shown in the drawings embodiments which are presently preferred, it being understood, however, that the invention is not limited to the precise arrangements shown.

FIG. 1 is a side view of one embodiment of the invention, in a collapsed configuration.

FIG. 2 is a side view of the embodiment of FIG. 1, in an expanded configuration.

FIG. 3 is an enlarged sectional view of part of the embodiment of FIG. 1, in a collapsed configuration.

FIG. 4 is an enlarged sectional view of part of the embodiment of FIG. 1, in an expanded configuration.

FIG. 5 is a part sectional view of another embodiment of the invention.

FIG. 6 is a side view of another embodiment of the invention.

FIG. 7 is a side view of another embodiment of the invention.

FIG. 8 is a side view of another embodiment of the invention.

FIG. 9 is a side view of another embodiment of the invention.

FIG. 10 is a side view of another embodiment of the invention.

FIG. 11 is a perspective view of a securing device for use with the invention.

FIG. 12 is a perspective view of another embodiment of the invention.

FIG. 13 is a perspective view of another embodiment of the invention.

### DETAILED DESCRIPTION OF PREFERRED EMBODIMENTS

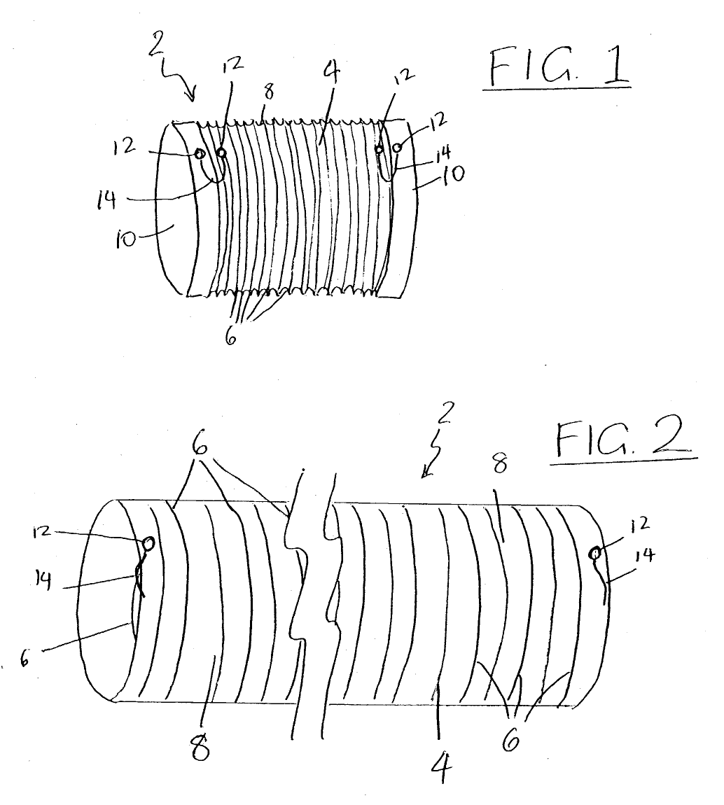

Referring now to the drawings, and more particularly to FIGS. 1-5, an apparatus 2 for the delivery of toxicant to vermin is illustrated. FIG. 5 illustrates a different embodiment of the invention to FIGS. 1 to 4, but like features will be described with like reference numerals herein. The apparatus includes a conduit 4 which can be formed of an expandable tube. The conduit 4 is configured for the passage of vermin therethrough in order that the vermin will contact a toxicant placed in the conduit. In one arrangement, as illustrated in FIGS. 1-4, the tube may be formed from a plurality of rigid hoops 6 joined by a tube of deformable material 8, although it will be appreciated that any suitable form of conduit or tube may be employed. The rigid hoops 6 may be formed of metal, and the deformable material may be a plastic sheet, but any suitable materials may be used. The conduit may be expanded and contracted by compressing the hoops 6 closer together or moving them further apart.

As shown in FIG. 5, in another arrangement, the conduit 4 may be formed of a folded material, where the folds extend around a periphery of the conduit. A suitable material for a conduit formed of a folded material is metal, such as aluminum. Any suitable material may be used, the material being deformable but of sufficient strength to retain the shape of the conduit over a period of use. The conduit 4 may be expanded and contracted by expanding or contracting the folds. It will be appreciated that any other suitable form of expansion and contraction may be employed in the conduit 4.

The conduit 4 may be formed of a biodegradable or burnable material such as coated cardboard or any other suitable material. If the conduit 4 is formed of a burnable material, it may be particularly suitable for use in agricultural settings such as, for example, sugar cane fields where the crop may grow and tangle around the conduit thus making removal of the used conduit difficult, and where the stalks of the plant are burned after the crop has been harvested.

The conduit may have any suitable length. As an example, the conduit may have a length of 6″ in a collapsed configuration and 30″ in an expanded configuration. With a folded material conduit, the length may be 7″ in a collapsed configuration and 24″ in an expanded configuration. Different lengths of conduit will be appropriate in different circumstances, such as desired location of the conduit and type of vermin infestation.

The conduit 4 may be sized to permit vermin such as rodents to pass through it without a large amount of clearance above or to the sides of the rodent. Thus, different sizes of conduit maybe employed for different sized rodents such as mice, Norway rats, Roof rats and other vermin. A suitable width of conduit for use with rats is approximately 3-4 inches, or 8 inches for use with large rats, but may be as large as 12 inches. The conduit may be smaller for smaller rodents such as mice. For insects such as cockroaches, a conduit having a smaller width or diameter (such as 1″) may be employed. It may be appropriate to employ very large diameter and length conduits for use with serious infestations, for example, in public places such as subway stations, so that a number of rodents or insects can pass through the conduit at the same time, or so that very large rats may be controlled.

The conduit 4 may have a circular cross-section, which has the most strength for a given size. Alternatively, the conduit 4 may have a square or rectangular cross-section, which enables the conduit to be easily installed, and prevents rolling of the conduit in use. Further alternative cross-sections include elliptical, triangular, pentagonal, hexagonal, heptagonal, octagonal or the conduit may have a polygonal shape with any number of sides.

The conduit 4 may be provided with end caps 10. The end caps may be attached to the ends of the conduits by any suitable means such as pop rivets 12 and flexible wire 14. Any suitable method of connecting the end caps to the conduits may be used. Alternatively, the end caps may simply be a push-fit on the ends of the conduit 4, or end caps may not be used in certain applications. If rivets 12 and wire 14 are employed, the end caps can remain with the conduit when installed, and may be replaced on the ends of conduit 4 when the conduit is removed from its installed location. The end caps can prevent spillage of any toxicant in the conduit 4 prior to its installation in a desired location.

In addition to or instead of end caps, grasping sections 15 (shown in FIG. 5) may be provided on the ends of conduit 4. The grasping sections 15 may simply be folded pieces of cardboard or other material that are placed over the ends of the conduit 4. Grasping sections can be particularly useful where the conduit 4 is made of metal, as the ends of the conduit 4 can be sharp when metal is used. The grasping sections 15 may include handle portions for ease of use. Alternatively, handle portions may be formed in the ends of the conduit 4.

The conduit 4 may also have a fastener (not shown) for maintenance of a collapsed configuration. Such a fastener can allow easy transport of the conduit, and safe disposal of the conduit after use. Alternatively, the conduit may be provided in a receptacle for storage and transport. The receptacle may be a box, bag or any other suitable container.

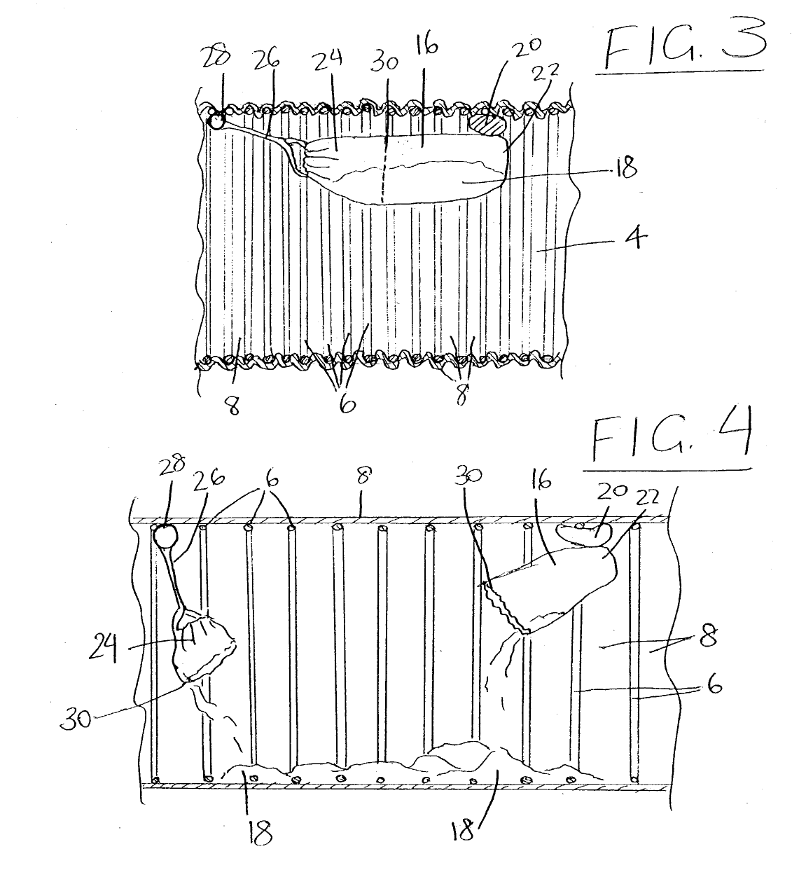

As can be seen most clearly in FIGS. 2 and 3, a container 16 may be provided in the interior of the conduit 4. The container 16 may hold a toxicant 18. Any suitable container may be used. The container can allow access to the toxicant once the conduit is installed. For example, the container may be breachable on installation, it may have a removable lid, or may disintegrate over time. Alternatively, no container may be used to supply toxicant, for example, an aperture may be provided in the conduit so that toxicant may be loaded into the container. As another example, a toxicant may be adhered to an internal surface of the conduit in such a way that vermin passing through the conduit will dislodge the toxicant onto their bodies.

The container 16 may be a deformable plastic container, such as a sealed bag. The container 16 may be attached to an interior surface of the conduit 4, for example by glue 20. The attachment of container 16 to conduit 4 may be at only one location on the container 16 or may be at several locations on container 16. As illustrated in FIG. 2, the container 16 may be attached at one end 22 to a section of the conduit 4 by glue 20. Another end 24 of the container 16 may be attached to another section of the conduit 4. In the illustrated embodiment, the end 24 of the container 16 is attached to the conduit 4 by a flexible wire 26 and a pop rivet 28. It will be appreciated that any suitable attachment method may be employed. For example, the bag may be glued at both ends to different sections of the conduit, or may be attached to the conduit by flexible wire 26 and pop rivets 28 positioned at both ends of the bag (as shown in FIG. 5).

The illustrated container 16 includes perforations 30 extending around the container between ends 22 and 24, which allow breach of the container 16 when the conduit 4 is expanded. As shown in FIG. 3, expansion of the conduit 4 upon installation causes the rivet 28 and hence the wire 26 and end 24 of the container 16 to be pulled away from the end 22 of the container 16. The perforations 30 rupture during the expansion of the conduit 4, causing the container 16 to break in two, depositing the toxicant 18 into the conduit 4. It will be appreciated that any suitable means of breaching the container 16 may be employed. Additionally, any suitable size of container may be used in order to vary the amount of toxicant provided in the conduit.

In another arrangement, the toxicant may be supplied with the conduit in a kit form, but not preloaded into the conduit. For example, a measured dose of conduit may be provided in a sealed container such as a flexible plastic bag that may be attached to an external surface of the conduit, or provided in packaging associated with the conduit. The plastic bag may be broken apart during installation, and the toxicant may be placed into the conduit immediately prior to expansion thereof. Alternatively, the toxicant packages may be supplied separately. In this arrangement, the toxicant may be pre-measured by the supplier for ease of use, but the user can purchase additional toxicant packages for re-use of the conduit, and can select between different toxicants if desired.

Alternatively, the toxicant may be simply scooped or otherwise measured or dispensed from a separate container during installation. This arrangement enables a user to select the type of toxicant depending on the type of vermin, and their own preferred working methods or proprietary toxicant formulations. The user may also choose the dosage of toxicant that is placed in the conduit.

The toxicant 18 may include any suitable rodenticide, insecticide or other poison. A preferred toxicant for use in controlling rat populations contains 2% or less of an active ingredient. A preferred active ingredient is an anticoagulant. A preferred formulation has approximately 0.2% or less of an anticoagulant. A preferred anticoagulant is 2-diphenylacetyl-1,3-indandione as the active ingredient. A suitable toxicant having 0.2% 2-diphenylacetyl-1,3-indandione is available under the name Ditrac (registered trademark) tracking powder from Bell Laboratories, Inc., Madison, Wis.

It has been found that a low concentration of active ingredient causes death of the vermin a long time after contact with the toxicant. While it may seem counterintuitive to allow the vermin to remain alive for several days or more after contact with the toxicant, this is advantageous with intelligent animals such as rats, because this arrangement prevents the rats from easily associating the toxicant container with the death of members of the rat population. The remaining members of the population therefore do not avoid the toxicant, causing death to a greater proportion of the population than would otherwise be the case. However, in certain applications it may be desirable to cause death to the vermin quickly, in which case a stronger percentage of active ingredient would be used, for example above 2% of active ingredient. An attractant such as sunflower seeds or other food item may be placed in the conduit to attract rodents, particularly rodents such as mice, which are not as attracted into conduits as rats.

A suitable insecticide for use with cockroaches may include borax. It will be appreciated that with cockroaches or other animals that do not associate the toxicant with the death of population members, there is no need to prevent the remaining population from associating the toxicant with the death of the animal, and so any suitable strength of toxicant may be used. With cockroaches, it is particularly advantageous to include an attractant with the toxicant so that the cockroaches are attracted into the conduit, because cockroaches are not naturally attracted into conduits, unlike rats. A suitable attractant may be a chemical attractant which sexually attracts cockroaches or other insects into the conduit.

In some circumstances, it may be desirable to include both rodenticides and insecticides in one conduit, or in different conduits placed into one area at the same time. For example, it is known that reducing or eliminating a rat population can result in an increase in a cockroach population in the area. Introducing insect control measures in the area along with rodent control measures may therefore be a useful pre-emptive step in order to prevent a rise in insect numbers as the rodent numbers are reduced.

In use of the apparatus, the conduit 4 is taken to its intended location in a collapsed configuration. The conduit 4 may be provided in a sealed container for storage and transport prior to use. The conduit 4 can be removed from the sealed container immediately prior to installation. The end caps 10 can be removed from the conduit 4, the conduit can be pulled into an expanded configuration and can be placed where the vermin are likely to be found. The expansion of the conduit 4 causes the rivet 28 and the wire 26 to be pulled away from the container 16, thus breaching the container and depositing the toxicant into the conduit. Suitable locations for placement of the conduit include, for example, voids between walls of a building, attics, roof spaces, basements, duct work, junctures of walls and floors, above suspended ceilings, beneath raised floors, and crawl spaces. Alternative locations may be external locations, such as in and around barns, silos and other storage facilities, alongside buildings, underneath buildings, along docks or in marinas, in subways or sewer systems, within fields of crops or pasture, in farming and recreational, around schools, factories, hospitals and places of work, yards and gardens of houses. Any location may be used, although it is preferable to use the conduits away from humans and animals, and in confined or darkened places.

The conduit may be replenished or replaced at regular intervals. If the conduit 4 is replaced, it may be contracted and the end caps 10 may be replaced on the ends of the conduit in order to prevent spillage of any toxicant remaining in the conduit. A fastener (not shown) may be used to retain the conduit in a collapsed configuration. Alternatively, a new container 16 may be added to the conduit 4, and the container 16 may be breached to release toxicant into the conduit 4. As another alternative, the conduit 4 may include one or more apertures, which may have resealable closure elements associated with them, so that new toxicant may be loaded into the conduit 4 through the apertures while the conduit 4 is in situ.

Alternative embodiments of the invention are illustrated in FIGS. 6-10. FIG. 6 shows a conduit 50 formed of a tube 52. The tube 52 may be a simple cardboard or plastic tube, or may have any suitable form. A container 54 is disposed approximately in the center of the tube. The container 54 may be cylindrical, with deformable ends 56 that may be formed of plastic or any other suitable material. The ends 56 may include perforations to enable easy breaching of the container. Pop rivets 58 may be connected to the ends 56, and may also be attached to wires 59. On installation of the conduit, the wires 59 may be pulled out of the ends of the tube 52 in order to breach the container 54 so that vermin may pass through the container and thus contact toxicant placed therein. Alternatively, no wires may be supplied, and the container may simply be breached by inserting a breaching element, such as a stiff wire, into the end of the conduit in order to puncture the walls of the container.

FIG. 7 illustrates another embodiment of the invention. A conduit 60 may be formed of a two-part telescoping tube 62, which is shown having a square cross-section, but may be of any suitable shape. The telescoping tube may have any suitable number of sections, as determined by the circumstances in which the conduit is to be used. A toxicant container 64 may be attached inside one part 66 of the tube 62, and may have a connection such as a wire 68 to another part 69 of the tube 62. Pulling the two (or more) telescoping parts apart in order to expand the conduit 60 causes breach of the toxicant container 64 in a similar manner to that described for FIG. 1, due to the wire 68 pulling on a portion of the container 64.

FIG. 8 shows a further embodiment of the invention. A conduit 70 may be formed of a multi-part telescoping tube 72. A multi-part telescoping tube may be compressed to a small volume for storage. A toxicant may be secured by adhesive onto an interior surface of one or more of the sections of the tube 72, such that the toxicant becomes exposed to the interior of the conduit 70 upon expansion of the tube 72. Alternatively, any suitable form of toxicant supply, such as a container, may be employed.

FIG. 9 shows a further embodiment of the invention. A conduit 80 is formed of three interlocking pipe segments 82, 84 and 86, that may be connected together to form a tube. A plurality of interlocking segments may be used to form a conduit of any desired length. An aperture 88 with a lid 90 may be provided in one or more of the segments for placing toxicant into the conduit. Alternatively, a container may be placed inside the tube that may be breached upon placement of the conduit in a desired location.

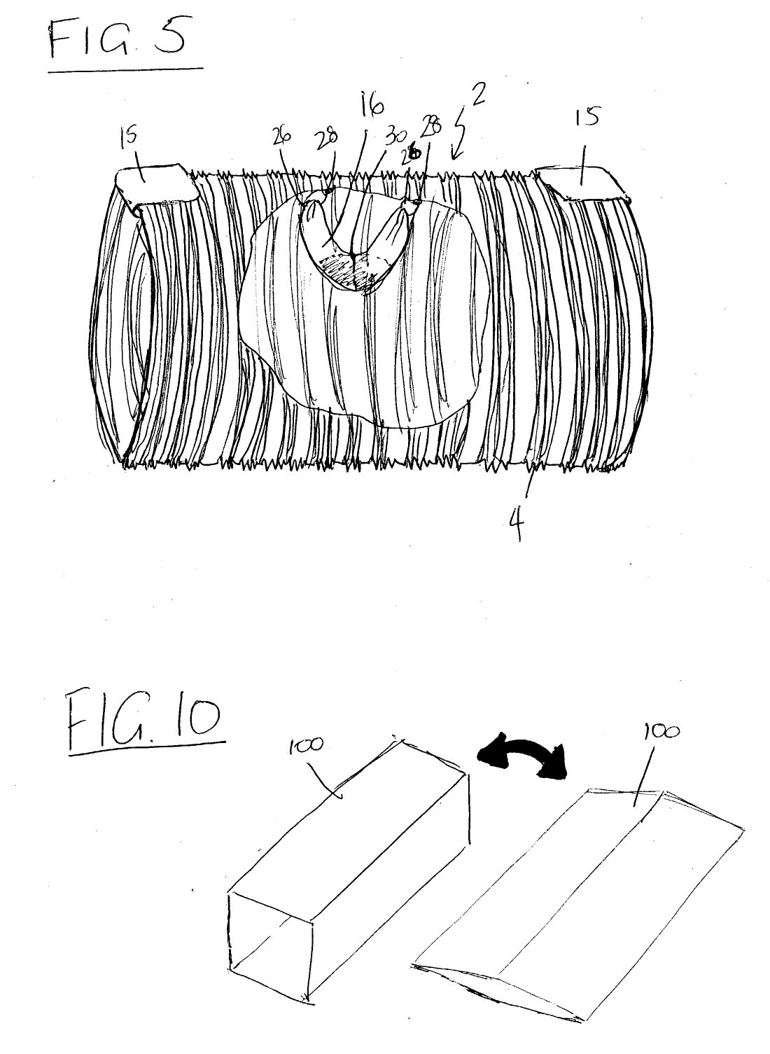

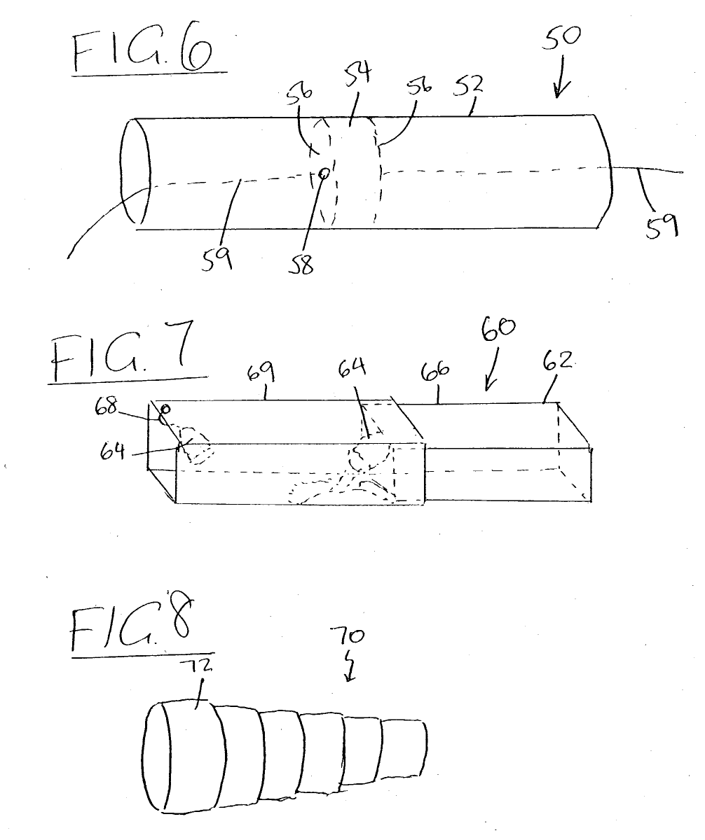

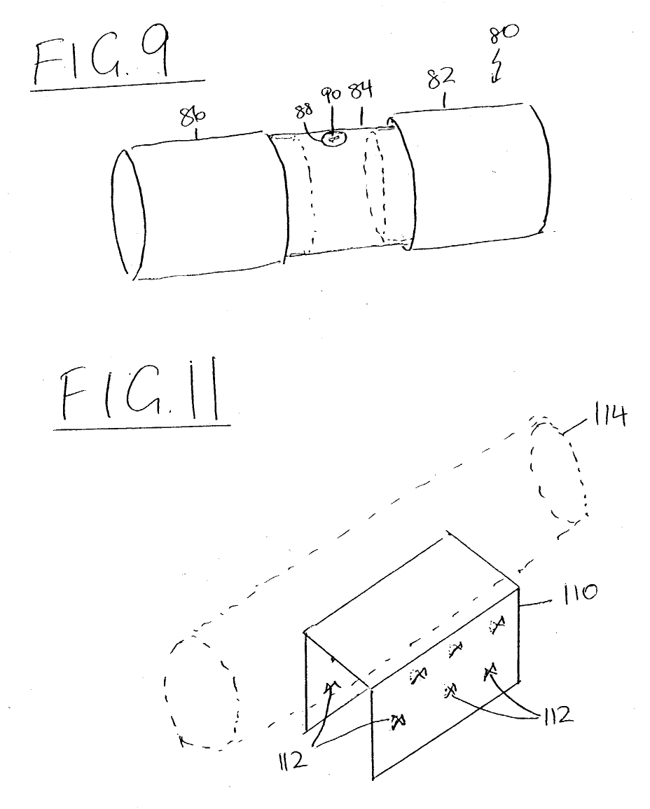

Yet a further embodiment of the invention is illustrated in FIG. 10. A conduit 100 may have a square or rectangular cross-section, and may be collapsible by folding or flattening lengthwise to flatten the conduit. On installation, the conduit 100 may be expanded by opening the conduit to its full height. The conduit may include a container (not shown) having toxicant preloaded therein. The container may be breachable on expansion of the conduit in order to release the toxicant into the conduit. The conduit 100 may or may not also be expandable lengthways.

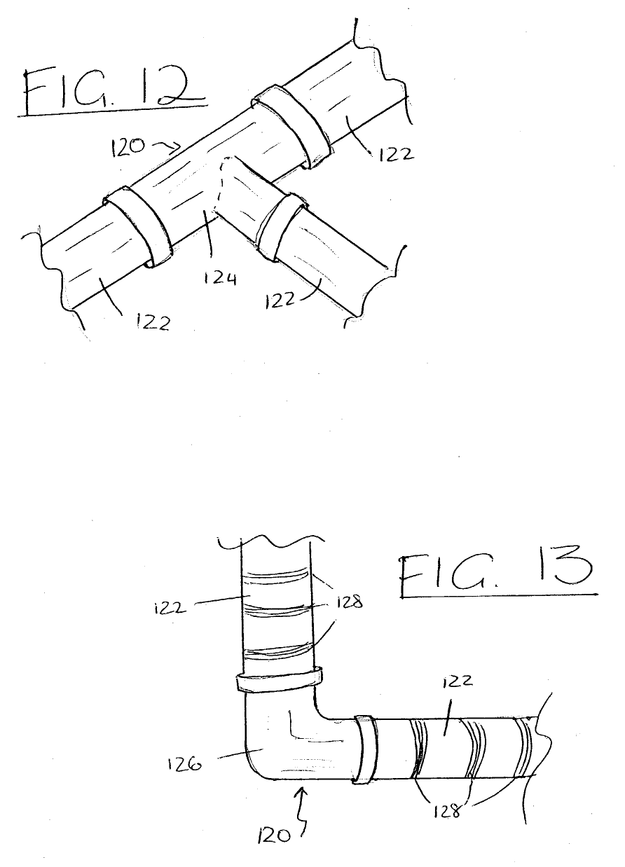

Any of the devices according to the invention may be secured into place by any suitable means, to prevent movement of the conduit. One suitable securing device is shown in FIG. 11, which depicts a bracket 110 for placement onto a roof beam or other structure. The bracket 110 can include projections 112 that can imbed into a beam to provide stability to the conduit. A conduit 114 (shown in dashed lines) may be secured on top of the bracket. Instead of or in addition to the illustrated bracket, any suitable securement means may be used to secure the conduit, such as tape, glue, any form of fastener such as nails, screws, hook and loop fastener, or any other means.

Turning now to FIGS. 12 and 13, a further arrangement of the invention is shown. In this arrangement, one or more modular connector sections 120 may be included, and may be used to attach two or more conduits 122 together. The connector sections 120 may take any suitable form, and may be a T-shaped connector 124 as shown in FIG. 12, a right-angle connector 126 as shown in FIG. 13, or any type of connector. Other shapes include acute angle connectors, obtuse angle connectors, straight connectors, cross-shaped connectors, U-shaped connectors, connectors for connecting both horizontal and vertical conduits, and any other connectors. The modular connector sections may be used to connect sections of conduit together in order that the conduit may extend around a right angled corner, or may extend over a long distance, or may conform to any shape that the installer deems appropriate to the vermin control situation. The conduits may be extendible, as indicated by representative folds 128 in FIG. 13. The connector sections are particularly appropriate for use in large installations where either long runs of conduits formed of a series of tubes aligned together are desired, where multiple turns must be incorporated into the conduits, or where a three-dimensional conduit arrangement is desired. Alternatively, by using the modular connectors, shorter sections of conduits may be used, which may be linked together to form any desired length of conduit. This reduces the amount of inventory a supplier needs to carry, as there is no need to keep different lengths of conduit in stock.

The modular connectors 124 and 126 may be formed in any suitable way, and may connect to the conduits in any suitable way. Any form of join between the conduits and the connectors may be used. For example, the modular connectors may be formed of a deformable plastic material, and may include a snap-fit 128 connection for placement of the connector 124 or 126 on an end of a conduit 122. In another arrangement, complementary bayonet or other twist fittings may be provided on the connector and the conduit. In yet further arrangements, the connectors may be a simple push fit onto the ends of the conduits. As an alternative to separate connectors, the conduits may have shaped ends to allow one end of one conduit to be a push fit or otherwise secured into an end of an adjacent conduit.

Where large arrangements of conduits and connectors are desired, either the conduits or the connectors or both may include access apertures into which toxicant may be loaded and/or reloaded. The access apertures may be provided with closures to close the aperture after loading of the toxicant. Alternatively, the toxicant may be loaded and/or reloaded by pulling the conduit and connector apart and simply placing the toxicant into the conduit or connector prior to reconnecting the connector and conduit.

The devices according to the invention may be used for vermin control. Particular success has been achieved with rat populations, enabling an area to be deemed free of vermin. In order to prevent repeat infestations, the invention also includes a method of managing an area which includes using a plurality of the devices in an area until the area is deemed free of vermin. After the area is deemed free of vermin, it is no longer necessary to keep devices according to the invention throughout the whole area, particularly with rats, which do not travel long distances from their original colonies to establish new colonies. Instead, in order to prevent a rat or other vermin population from moving into the cleared area, a plurality of devices may be set up around the periphery of the cleared area. This will insure that any rats or other vermin moving into the area will pass one or more of the devices, because animals such as rats do not simply invade an area, but move slowly and cautiously into an area and are very likely to investigate any conduits in their path.

Typically, once an area is cleared of vermin, it is desirable to clear a neighboring area of vermin so that very large infestations can be cleared in a controlled manner without the need to blanket the area with a very large number of devices. When the neighboring area is deemed to be clear of vermin, the periphery of devices can be expanded to include both the first cleared area and the second cleared area. This can be continued until the entire area to be controlled is deemed free of vermin.

In an arrangement of the invention, all necessary component parts for controlling vermin in an area may be supplied in kit form. For example, if in one arrangement a total of 10 conduits are recommended for an area of 1000 square feet, a 10-conduit kit may be provided. The kit may be marketed as being suitable for 1000 square feet (or any other area size, depending on the number and size of conduits) in order that a user can purchase the correct kit for the area concerned. The kit may include the conduits, one or several doses or containers of toxicant, one or several modular connectors for connecting conduits together, and instructions. The instructions may include dosing instructions, replenishment or reloading instructions, a diagram showing suitable conduit placements, instructions for placing the conduits around the periphery of the area once the area has been cleared, etc. Safety information may also be provided.

It should be understood that the examples and embodiments described herein are for illustrative purposes only and that various modifications or changes in light thereof will be obvious to persons skilled in the art, and that such modifications or changes are to be included within the spirit and purview of this application. Moreover, the invention can take other specific forms without departing from the spirit or essential attributes thereof.

What is claimed is:

1. An apparatus for the delivery of toxicant to vermin comprising:
an expandable conduit having an entry and exit for vermin;
wherein the conduit is expandable upon installation into an area determined to be suitable for vermin control; and
wherein a toxicant is placeable in the expanded conduit such that vermin will contact the toxicant when passing through the conduit.

2. The apparatus of claim 1, wherein toxicant is preloaded into said conduit when said conduit is in a collapsed configuration prior to expansion.

3. The apparatus of claim 1, wherein said conduit is reversibly expandable.

4. The apparatus of claim 1, wherein said conduit is formed of metal.

5. The apparatus of claim 2, further comprising a container for the storage of said toxicant.

6. The apparatus of claim 6, wherein said container is breachable to release said toxicant into said conduit.

7. The apparatus of claim 6, wherein said toxicant is released from said container upon expansion of said conduit.

8. The apparatus of claim 6, wherein a linking element couples said container and a portion of said conduit, wherein said linking element causes breach of said container upon expansion of said conduit.

9. The apparatus of claim 6, wherein said container has perforations enabling breach of said container.

10. The apparatus of claim 5, wherein said container is refillable.

11. The apparatus of claim 5, wherein said container is replaceable.

12. The apparatus of claim 5, wherein said container is formed of plastic material.

13. The apparatus of claim 5, wherein said container is deformable.

14. The apparatus of claim 5, wherein said container is located substantially near a midpoint of said conduit.

15. The apparatus of claim 1, wherein said conduit includes a plurality of folds extending around a circumference of said conduit, said folds allowing expansion and contraction of the conduit.

16. The apparatus of claim 1, wherein said conduit further comprises at least one rigid reinforcement member extending around a circumference of said conduit, and a deformable material.

17. The apparatus of claim 16, further comprising a plurality of reinforcement members, wherein each reinforcement member is substantially circular, and wherein the deformable material extends between said plurality of reinforcement members to form an expandable and collapsible tube.

18. The apparatus of claim 1, further comprising end sealing elements.

19. The apparatus of claim 18, wherein said end sealing elements are end caps.

20. The apparatus of claim 1, further comprising end grasping elements.

21. The apparatus of claim 1, wherein said toxicant comprises an active ingredient which forms less than approximately 2% of the toxicant.

22. The apparatus of claim 21, wherein said active ingredient comprises less than approximately 0.2% of the toxicant.

23. The apparatus of claim 21, wherein said active ingredient is an anticoagulant.

24. The apparatus of claim 21, wherein said active ingredient is 2-Diphenylacetyl-1,3-indandione.

25. The apparatus of claim 1, wherein the vermin is a rodent.

26. The apparatus of claim 25, wherein the rodent is a rat.

27. The apparatus of claim 1, wherein said conduit further comprises an aperture for replenishment of said toxicant.

28. The apparatus of claim 1, comprising at least two conduits, wherein the conduits are connectable together.

29. The apparatus of claim 28, wherein said at least two conduits are connectable together by a connector.

30. The apparatus of claim 29, wherein said connector is a snap-fit on ends of said at least two conduits.

31. The apparatus of claim 29, wherein said connector is at least one of straight, right-angled, T-shaped, cross-shaped, and U-shaped.

32. A method for the delivery of toxicant to vermin, comprising the steps of:
providing an expandable conduit having an entry and exit for vermin;
expanding the conduit thereby providing a passageway for the vermin;
locating the conduit in an area selected for vermin management; and
disposing the toxicant within the conduit.

33. The method of claim 32, wherein the conduit is reversibly expandable.

34. The method of claim 32, wherein the toxicant is preloaded into the conduit prior to location of the conduit in the selected area.

35. The method of claim 32, wherein the conduit further comprises a container for the storage of the toxicant, the method further comprising the step of filling the container with the toxicant prior to expansion of the conduit.

36. The method of claim 35, where said container is breachable, the method further comprising breaching the container on placement of said conduit to thereby release the toxicant into the conduit.

37. The method of claim 36, wherein the toxicant is released from the container upon expansion of the conduit.

38. The method of claim 37, wherein a linking element couples the container and a portion of the conduit, wherein the linking element causes the breach of the container upon expansion of the conduit.

39. The method of claim 32, further comprising the step of placing a plurality of conduits into the selected area.

40. The method of claim 32, further comprising the step of securing the conduit into a desired location within the selected area.

41. The method of claim 32, further comprising the step of selecting a location for placement of the conduit based on behavioral patterns of the vermin.

42. The method of claim 41, wherein the locations are selected from the group consisting of voids between walls of a building, attics, roof spaces, basements, duct work, junctures of walls and floors, above suspended ceilings, beneath raised floors, crawl spaces, in and around barns, silos and other storage facilities, alongside buildings, underneath buildings, along docks or in marinas, in subways or sewer systems, within fields of crops or pasture, in farming and recreational, around schools, factories, hospitals and places of work, and yards and gardens of houses.

43. The method of claim 32, wherein the conduit further comprises a fastener mechanism for maintenance of a collapsed configuration, the method further comprising the step of unfastening the fastener to enable expansion of the conduit.

44. The method of claim 32, wherein the conduit further comprises end sealing caps to enable transport of the conduit without spillage of the toxicant, the method further comprising the step of removing the end caps on location of the conduit in the selected area.

45. The method of claim 32, further comprising the step of selecting a toxicant having less than approximately 2% of active ingredient.

46. The method of claim 45, wherein the active ingredient comprises less than approximately 0.2% of the toxicant.

47. The method of claim 45, wherein the active ingredient is an anticoagulant.

48. The method of claim 45, wherein the active ingredient is 2-Diphenylacetyl-1,3-indandione.

49. The method of claim 32, wherein the vermin to be managed is a rodent.

50. The method of claim 49, wherein the rodent is a rat.

51. The method of claim 32, comprising at least two conduits, wherein the conduits are connectable together.

52. The method of claim 51, wherein said at least two conduits are connectable together by a connector.

53. The method of claim 51, wherein said connector is a snap-fit on ends of said at least two conduits.

54. The method of claim 51, wherein said connector is at least one of straight, right-angled, T-shaped, cross-shaped, and U-shaped.

55. The method of claim 32, wherein the conduit further comprises an aperture for replenishment of the toxicant, and wherein the method further comprises the step of replenishing the toxicant after the toxicant has been delivered to the vermin.

56. The method of claim 55, wherein the replenishment of the toxicant is refilling the toxicant in the conduit.

57. The method of claim 55, wherein the replenishment of the toxicant is replacing the toxicant in the conduit.

58. An apparatus for the delivery of toxicant to vermin comprising:
a conduit having an entry and exit for vermin; and
a toxicant disposed within said conduit between said entry and exit,
wherein said toxicant is secured within said conduit to thereby prevent spillage of said toxicant upon installation of the apparatus.

59. The apparatus of claim 58, further comprising a container for the storage of said toxicant.

60. The apparatus of claim 59, where said container is breachable to release said toxicant into said conduit.

61. The apparatus of claim 59, wherein said container has perforations enabling a breach of said container.

62. The apparatus of claim 61, wherein said container is formed of plastic material.

63. The apparatus of claim 59, wherein said container is deformable.

64. The apparatus of claim 59, wherein said container is located substantially near a midpoint of said conduit.

65. The apparatus of claim 59, wherein said container is refillable.

66. The apparatus of claim 59, wherein said container is replaceable.

67. The apparatus of claim 58, wherein said conduit further comprises an aperture for replenishment of said toxicant.

68. The apparatus of claim 58, wherein said conduit is formed of metal.

69. The apparatus of claim 58, wherein said conduit is expandable.

70. The apparatus of claim 69, further comprising a container for storage of said toxicant, wherein said toxicant is released from said container upon expansion of said conduit.

71. The apparatus of claim 70, wherein a linking element couples said container and an end of said conduit, wherein said linking element causes breach of said container upon expansion of said conduit.

72. The apparatus of claim 69, wherein said conduit includes a plurality of folds extending-around a circumference of said conduit, said folds allowing expansion and contraction of the conduit.

73. The apparatus of claim 69, wherein said conduit further comprises a least one rigid reinforcement member extending around a circumference of said conduit, and a deformable material.

74. The apparatus of claim 73, further comprising a plurality of reinforcement members, wherein each reinforcement member is substantially circular, and wherein the deformable material extends between said plurality of reinforcement members to form an expandable and collapsible tube.

75. The apparatus of claim 58, further comprising end sealing elements.

76. The apparatus of claim 75, wherein said end sealing elements are end caps.

77. The apparatus of claim 58, further comprising end grasping elements.

78. The apparatus of claim 58, where said toxicant comprises an active ingredient which forms less than approximately 2% of the toxicant.

79. The apparatus of claim 78, wherein said active ingredient comprises less than approximately 0.2% of the toxicant.

80. The apparatus of claim 78, wherein said active ingredient is an anticoagulant.

81. The apparatus of claim 78, wherein said active ingredient is 2-Diphenylacetyl-1,3-indandione.

82. The apparatus of claim 58, wherein the vermin is a rodent.

83. The apparatus of claim 82, wherein the rodent is a rat.

84. The apparatus of claim 58, comprising at least two conduits, wherein the conduits are connectable together.

85. The apparatus of claim 84, wherein said at least two conduits are connectable together by a connector.

86. The apparatus of claim 85, wherein said connector is a snap-fit on ends of said at least two conduits.

87. The apparatus of claim 85, wherein said connector is at least one of straight, right-angled, T-shaped, cross-shaped, and U-shaped.

88. A method for the delivery of toxicant to vermin, comprising the steps of:
providing a conduit having an entry and exit;
providing a preloaded toxicant disposed within the conduit between the entry and exit; and
locating the conduit in an area selected for vermin management.

89. The method of claim 88, wherein the conduit further comprises a container for the storage of the toxicant, and wherein the method further comprises the step of filling the container with the toxicant prior to location of the conduit in the selected area.

90. The method of claim 89, where the container is breachable and the method further comprises breaching the container on location of the conduit.

91. The method of claim 88, wherein the container is refillable.

92. The method of claim 88, wherein the container is replaceable.

93. The method of claim 89, wherein the conduit is expandable, and wherein the method further comprises releasing the toxicant from the container upon expansion of the conduit.

94. The method of claim 89, wherein the container has perforations enabling a breach of the container.

95. The method of claim 93, wherein a linking element couples said container and a portion of the conduit, and wherein the linking element causes the breach of the container upon expansion of the conduit.

96. The method of claim 89, wherein the container is located substantially near a midpoint of the conduit.

97. The method of claim 88, wherein the conduit is sized to permit vermin to pass therein.

98. The method of claim 88, wherein the conduit further comprises end sealing caps to enable transport of the conduit without spillage of the toxicant, the method further comprising the step of removing the end caps on location of the conduit in the selected area.

99. The method of claim 88, further comprising the step of selecting a toxicant having less than approximately 2% of active ingredient.

100. The method of claim 99, wherein the active ingredient comprises less than approximately 0.2% of the toxicant.

101. The method of claim 99, wherein the active ingredient is an anticoagulant.

102. The method of claim 99, wherein the active ingredient is 2-Diphenylacetyl-1,3-indandione.

103. The method of claim 88, wherein the vermin to be managed is a rodent.

104. The method of claim 103, wherein the rodent is a rat.

105. The method of claim 88, wherein the conduit further comprises an aperture for replenishment of the toxicant, and wherein the method further comprises the step of replenishing the toxicant after the toxicant has been delivered to the vermin.

106. The method of claim 105, wherein the replenishment of the toxicant is refilling the toxicant in the conduit.

107. The method of claim 105, wherein the replenishment of the toxicant is replacing the toxicant in the conduit.

108. The method of claim 88, wherein the method further comprises securing the conduit into a desired location.

109. The method of claim 88, wherein the method further comprises placing a plurality of conduits into said area.

110. The method of claim 88, further comprising selecting a location for placement of said conduit based on social and behavioral patterns of the vermin.

111. The method of claim 110, wherein the locations are selected from the group consisting of voids between walls of a building, attics, roof spaces, basements, duct work, junctures of walls and floors, above suspended ceilings, beneath raised floors, crawl spaces, in and around barns, silos and other storage facilities, alongside buildings, underneath buildings, along docks or in marinas, in subways or sewer systems, within fields of crops or pasture, in farming and recreational, around schools, factories, hospitals and places of work, and yards and gardens of houses.

112. The method of claim 88, wherein at least two conduits are used, and wherein the method includes connecting the at least two conduits together.

113. The method of claim 112, wherein said at least two conduits are connectable together by a connector.

114. The method of claim 112, wherein said connector is a snap-fit on ends of said at least two conduits.

115. The method of claim 112, wherein said connector is at least one of straight, right-angled, T-shaped, cross-shaped, and U-shaped, the method comprising connecting conduits together in a shape dictated by the shape of the connector.

116. A method for the management of vermin from an area comprising the steps of:
providing a toxicant having less than approximately 2% active ingredient in a toxicant receptacle;
locating a plurality of the toxicant receptacles in a first area containing vermin; and
managing of the first area by replenishment of the toxicant receptacles.

117. The method of claim 116, wherein the active ingredient of the toxicant comprises less than approximately 0.2% of the toxicant.

118. The method of claim 116, wherein the active ingredient is an anticoagulant.

119. The method of claim 116, wherein the active ingredient is 2-Diphenylacetyl-1,3-indandione.

120. The method of claim 116, further comprising removing toxicant receptacles from within the first area, and locating a plurality of toxicant receptacles around the periphery of the first area when the first area is deemed vermin free.

121. The method of claim 116, further comprising selecting a second area for vermin management adjoining the first area when the first area is deemed vermin free, repeating the method in the second area until the second area is deemed vermin free and providing a plurality of the toxicant receptacles around the periphery of the first and second adjoining areas, thereby expanding the periphery of managed area.
